(19) United States
(12) Patent Application Publication
(10) Pub. No.: US 2026/0080100 A1
(43) Pub. Date: Mar. 19, 2026

(54) INFORMATION PROCESSING DEVICE

(71) Applicant: TOYOTA JIDOSHA KABUSHIKI KAISHA, Toyota-shi Aichi-ken (JP)

(72) Inventor: Ryo Hashimoto, Suginami-ku Tokyo-to (JP)

(73) Assignee: TOYOTA JIDOSHA KABUSHIKI KAISHA, Toyota-shi Aichi-ken (JP)

(21) Appl. No.: 19/326,138

(22) Filed: Sep. 11, 2025

(30) Foreign Application Priority Data
Sep. 18, 2024 (JP) 2024-161307

(51) Int. Cl. G06F 21/62

(52) U.S. Cl. CPC G06F 21/6254

(57) ABSTRACT

An information processing device has a processor configured to generate vehicle data having serial data in which a plurality of non-image information with different attributes is disposed in predetermined positions, carry out concealment processing with respect to information of the attribute to be protected in the vehicle data using a protection mask having serial data of the same length as information of an attribute to be protected, and an output device for outputting the vehicle data subjected to the concealment processing.

### CROSS-REFERENCE TO RELATED APPLICATIONS

This application claims priority to Japanese Patent Application No. 2024-161307 filed Sep. 18, 2024, the entire contents of which are herein incorporated by reference.

### FIELD

The present disclosure relates to an information processing device.

### BACKGROUND

A data collecting device mounted on a vehicle collects information of the vehicle and the occupant, and transmits the information to a server as vehicle information. The occupant includes a driver. The server receives and stores the vehicle information. The vehicle information collected in the server, for example, is used in the development of the control technology of the vehicle.

Here, the vehicle information includes personal information about the occupant. For example, the information about the acceleration and deceleration operations of the vehicle may include personal information about the driving of the driver.

Therefore, it has been proposed to carry out privacy processing on the vehicle information (e.g., see Japanese Unexamined Patent Publication No. 2023-180929). In the privacy processing, privacy data included in the image data, for example, privacy identifiable data such as a pedestrian's face, a vehicle number, a place name, and a store name, is masked.

### SUMMARY

By the way, the collection of information may be subjected to laws and regulations.

And the type of information protected by laws and regulations can be changed.

Accordingly, an object of the present disclosure is to provide an information processing device that can easily protect a portion of information collected from a vehicle that is to be protected, in response to changes in the subject of protection.
(1) According to one embodiment, an information processing device is provided. This information processing device has a processor configured to generate vehicle data having serial data in which a plurality of non-image information with different attributes is disposed in predetermined positions, carry out concealment processing with respect to information of the attribute to be protected in the vehicle data using a protection mask having serial data of the same length as information of an attribute to be protected, and an output device for outputting the vehicle data subjected to the concealment processing.
(2) In the information processing device of embodiment (1), the processor is further configured to carry out the concealing processing so that information is concealed with respect to the information of the attribute to be protected and information is not changed with respect to information of an attribute not to be protected by using protection serial data including the same length as the vehicle data in which the protection mask is disposed at a position corresponding to the information of the attribute to be protected.
(3) In the information processing device of embodiment (1) or (2), all bits of the protection mask are zero.
(4) In the information processing device of embodiment (2) or (3), the processor is further configured to generate the protection mask and the protection serial data based on a position of the information of the attribute to be protected in the vehicle data and a length of the information of the attribute to be protected.
(5) In the information processing device according to any one of embodiments (1) to (4), the information of the attribute to be protected is associated with personal information.

According to the information processing device of the present disclosure, an effect of easily protecting a portion of information collected from a vehicle that is to be protected, in response to changes in the subject of protection is obtained.

The object and aspects of the present disclosure will be realized and attained by the elements and combinations particularly specified in the claims. It is to be understood that both the foregoing general description and the following detailed description are exemplary and explanatory, and are not restrictive of the present disclosure, as claimed

### BRIEF DESCRIPTION OF DRAWINGS

FIG. 1 is a schematic configuration diagram of a data collecting system in which a data collecting device of the present embodiment is mounted.

FIG. 2 is an example of a sequence diagram of a data collecting processing of the data collecting system of the present embodiment.

FIG. 3 is a hardware configuration diagram of a vehicle in which the data collecting device is mounted.

FIG. 4 is an example of an operation flowchart of the information processing of the data collecting device.

FIG. 5A is a diagram illustrating an example of the vehicle information.

FIG. 5B is a diagram for illustrating the masking processing.

FIG. 6A is a diagram for illustrating a modified example of the data collecting device.

FIG. 6B is a diagram for illustrating another example of generating a mask.

### DESCRIPTION OF EMBODIMENTS

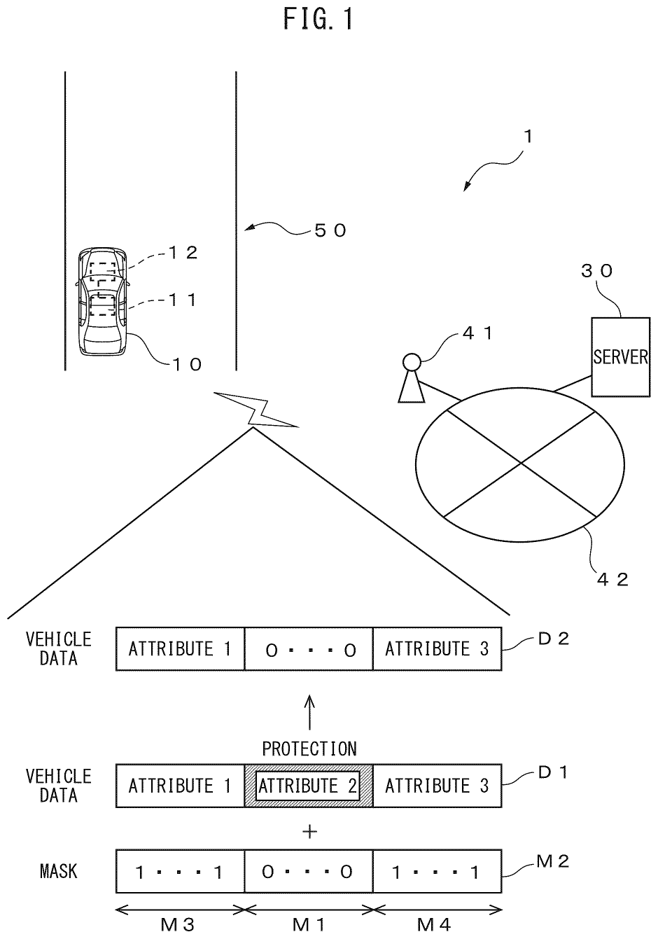

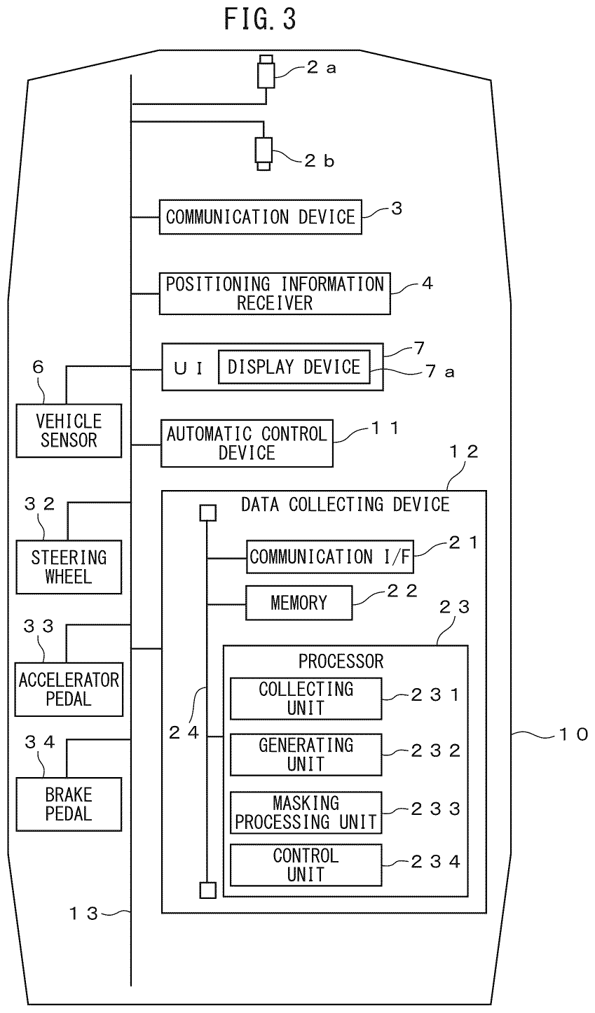

FIG. 1 is a schematic configuration diagram of a data collecting system 1 in which a data collecting device 12 of the present embodiment is mounted. FIG. 3 is a hardware configuration diagram of a vehicle on which the data collecting device is mounted.

The data collecting system 1 has at least one vehicle 10 and a server 30. The automatic control device 11 and the data collecting device 12 are mounted on the vehicle 10. The data collecting device 12 is an example of an information processing device. The vehicle 10 is connected to the server 30 via the wireless base station 41 (hereinafter also referred to as a macrocell base station 41) and the communication network 42, for example, by accessing the macrocell base station 41 that provides macrocell connected to the communication network 42 to which the server 30 is connected via a gateway (not shown) or the like.

In FIG. 1, although only one vehicle 10 is shown, the data collecting system 1 may have a plurality of vehicles. Similarly, a plurality of macrocell base stations 41 may be connected to the communication network 42.

The vehicle 10 is traveling on a road 50. The automatic control device 11 has an automatic operation mode in which the automatic control device 11 mainly operates the vehicle 10 (e.g., operation mode of level 3-5) and a manual operation mode in which the driver (not shown) mainly drives the vehicle 10 (e.g., operation mode of level 0-2). The vehicle 10 may be an autonomous vehicle.

In the manual operation mode, the automatic control device 11 controls the operation of the vehicle 10 based on the operation of the driver. The driver is seated in the driver's seat (not shown) inside the vehicle cabin, and operates the steering wheel 32, accelerator pedal 33 and brake pedal 34.

The data collecting device 12 mounted on the vehicle 10 transmits vehicle data acquired in the vehicle 10 to the server 30. The vehicle data includes, for example, occupant data relating to the operation of the vehicle 10 by the occupant, driving data representing the state of the vehicle 10, environmental data representing the environment around the vehicle, and the like.

The occupant data includes, for example, the frequency of the driver's looking aside, the frequency of the driver's yawing, and the operation information of the steering wheel 32, accelerator pedal 33, and brake pedal 34. The driving data includes, for example, the speed of the vehicle 10, and the angular velocity. The environmental data includes information such as, for example, the position of signs (signboards) around the vehicle 10, the size of the signs, telephone numbers represented on the signs, and the like. The environmental data may also include information such as the position of other vehicles around the vehicle 10, license plates of vehicles, size, color, and the like.

The occupant data may include personal information of the driver. The environmental data may also include personal information of the advertiser displaying the sign.

The server 30 receives the vehicle data from the vehicle 10, which is used to improve vehicle control, generate or update high precision maps. The vehicle data is used, for example, as teacher data for machine learning. The autonomous vehicle relies on the high precision map to operate automatically. The vehicle data may include personal information such as identifying an occupant.

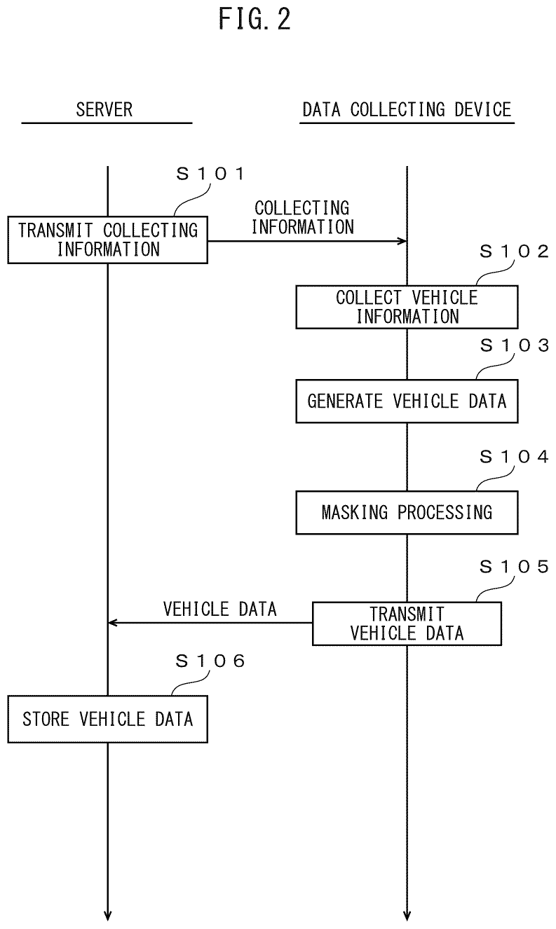

FIG. 2 is an example of a sequence diagram of a data collecting processing of the data collecting system 1 of the present embodiment. Referring to FIG. 2, the operation of the data collecting system 1 will be outlined below. In FIG. 1, although only one vehicle 10 is illustrated, the server 30 is capable of carrying out the same processing for a plurality of vehicles.

First, the server 30 transmit the collecting information representing the vehicle data to be collected to the vehicle 10 via the communication network 42 and the macrocell base station 41 (step S101). The collecting information includes, for example, information representing data such as the occupant data, driving data and environmental data to be collected, and the area where the vehicle data is collected, and the like.

Next, the data collecting device 12 starts collecting vehicle information according to the collecting information (step S102). The data collecting device 12 collects steering signals representing operation of the steering wheel 32 by the driver, accelerator signals representing operation of the accelerator pedal 33 by the driver, and brake signals representing operation of the brake pedal 34 by the driver, as the occupant data, for example. The steering, accelerator, and brake signals represent the driver's driving characteristics and therefore include the driver's personal information.

The data collecting device 12 collects the speed, angular velocity and acceleration of the vehicle 10 as the driving data, for example. In addition, the data collecting device 12 collects information such as the position of sign around the vehicle 10, the size of the sign, and the telephone number represented on the sign as environmental data, for example.

Next, the data collecting device 12 generates vehicle data based on the collected vehicle information (step S103). As shown in FIG. 1, the vehicle data has serial data in which each of a plurality of non-image information with different attributes is disposed at a predetermined position. For example, the data collecting device 12 generates vehicle data D1 having information of attribute 1 representing the driving data, information of attribute 2 representing the occupant data, and information of attribute 3 representing the environmental data. The vehicle data D1 is serial data in which a plurality of bits 0 and bits 1 are arranged in series.

Next, the data collecting device 12 carries out masking processing with respect to the information of the attribute 2 to be protected in the vehicle data D1 using a mask M1 having serial data of the same length as the information of the attribute 2 to be protected to obtain vehicle data D2 (step S104). The mask M1 is an exemplary protection mask. The masking processing is exemplary concealment processing. The mask M1 has serial data having the same length as the data of attribute 2 representing the occupant data. According to the masking processing, the structure of the vehicle data D1 is preserved while changing the plurality of bits 0 and 1 representing the information of attribute 2 to protect the confidentiality of the information of attribute 2.

In the example shown in FIG. 1, the data collecting device 12 generates a mask M2 consisting of serial data having the same length as the vehicle data D1. The mask M2 is an exemplary protection serial data. In the mask M2, the mask M1 is disposed at a position corresponding to a position where the information of the attribute 2 to be protected is disposed in the vehicle data D1. In the mask M2, the bits other than the portion where the mask M1 is placed are 1. In the mask M1, all bits may be 0.

The data collecting device 12 carries out the masking processing so that information is concealed with respect to the information of the attribute to be protected and information is not changed with respect to information of an attribute not to be protected by using the mask M2. Specifically, the data collecting device 12 carries out an AND operation between the vehicle data D1 and the mask M2 to obtain the vehicle data D2. Thus, the AND operation is carried out between the information having the attribute 2 to be protected in the vehicle data D1 and the mask M1.

In the vehicle data D2, the data of attribute 2 to be protected has all zero bits as a result of the AND operation. The AND operation does not change the information of the attribute 1 and attribute 3, which are not to be protected in vehicle data D2 from vehicle data D1. The masking processing protects only the information of the attribute 2 of the vehicle data D2.

The above description uses the mask M1 to protect the occupant data. Similarly, the driving data is protected when a mask M3 with all zero bits is used. The environmental data is protected when a mask M4 with all zero bits is used.

The data collecting device 12 then transmits the vehicle data D2 to the server 30 via the macrocell base station 41 and the communication network 42 (step S105).

The server 30 then stores the vehicle data D2 (step S106) and the series of processing steps is complete. In the vehicle data D2 stored by the server 30, the portion of the occupant data is protected since all information of the attribute 2 is zero.

According to the data collecting system 1 of the present embodiment described in detail above, the data collecting device 12 can easily protect a portion of information collected from the vehicle 10 that is to be protected, in response to changes in the subject of protection.

The data collecting system 1 may include a plurality of vehicles 10, but one vehicle 10 will be described below since each vehicle may have the same configuration and carries out the same processing with respect to the information processing.

Next, the vehicle 10 on which the data collecting device 12 is mounted will be described below with reference to FIG. 2.

The vehicle 10 has a front camera 2a, a monitoring camera 2b, a communication device 3, a positioning information receiver 4, a vehicle sensor 6, a user interface (UI) 7, a steering wheel 32, an accelerator pedal 33, a brake pedal 34, the automatic control device 11, and the data collecting device 12, etc. The vehicle 10 may further have a ranging sensor (not shown) for measuring the distance to objects surrounding the vehicle 10, such as a LIDAR sensor.

The front camera 2a, monitoring camera 2b, communication device 3, positioning information receiver 4, vehicle sensor 6, user interface (UI) 7, steering wheel 32, accelerator pedal 33, brake pedal 34, automatic control device 11, and data collecting device 12 are communicatively connected via an in-vehicle network 13 conforming to standards such as a controller area network.

The front camera 2a is mounted on the vehicle 10 and directed toward the front of the vehicle 10. The front camera 2a, for example, captures camera images representing a predetermined area of the environment in front of the vehicle 10 at a predetermined period. The camera image is an example of information representing the environment around the vehicle. The camera image may represent roads contained within the predetermined area in front of the vehicle 10 and road features around the roads.

The front-camera 2a has a 2D detector composed of an array of photoelectric conversion elements with visible light sensitivity, such as a CCD or C-MOS, and an imaging optical system that forms an image of the captured region on the 2D detector each time the camera image is captured, the front camera 2a outputs the camera image and the camera image acquisition time at which the camera image has been captured to the automatic control device 11 and the data collecting device 12 via the in-vehicle network 13.

The monitoring camera 2b is disposed in the cabin in a manner allowing the monitoring camera 2b to capture monitoring images including the face of the driver driving the vehicle 10. The monitoring camera 2b, for example, is disposed on a dashboard. The monitoring camera 2b is an exemplary image capturing unit. The monitoring camera 2b, for example, captures monitoring images representing the vicinity of the driver's seat at the monitoring image acquisition time having a predetermined period. The monitoring image represents the face of the driver seated in the driver's seat.

As the monitoring camera 2b, it is possible to use the same as the front camera 2a. Each time the monitoring image is captured, the monitoring camera 2b, outputs the monitoring image and the image acquisition time at which the monitoring image is captured to the automatic control device 11 via the in-vehicle network 13. In the automatic control device 11, the monitoring image is used, for example, to monitor the state of the driver.

The communication device 3 has interface circuitry for connecting the data collecting device 12 to the macrocell base station 41. The communication device 3 is configured to communicate with the server 30 via the macrocell base station 41 and the communication network 42. The communication device 3 is an example of a device communication unit. The communication device 3 is an example of an output device.

The positioning information receiver 4 outputs positioning information that represents the current position of the vehicle 10. The positioning information receiver 4 may be a GNSS receiver, for example. The positioning information receiver 4 outputs positioning information and the positioning information acquisition time at which the positioning information has been acquired, to the automatic control device 11 and the data collecting device 12, each time positioning information is acquired at a predetermined receiving cycle. The positioning information includes, for example, the current position of the vehicle 10 represented by the world coordinates. The current position of the vehicle 10 includes, for example, the latitude and longitude.

The vehicle sensor 6 detects the state of the vehicle 10 and outputs sensor signals representing the state of the vehicle 10 to the automatic control device 11 and the data collecting device 12 via the in-vehicle network 13. The vehicle sensor 6, for example, detects the speed, angular velocity and acceleration of the vehicle 10. The data collecting device 12 can collect the driving data based on the sensor signals.

The steering wheel 32 generates steering signals based on the steering angle by the driver's operation and outputs the steering signals to the automatic control device 11 and the data collecting device 12 via the in-vehicle network 13. The data collecting device 12 can collect the steering signals as the occupant data.

The accelerator pedal 33 generates accelerator signals based on the degree of accelerator opening by the driver's operation and outputs the signals to the automatic control device 11 and the data collecting device 12 via the in-vehicle network 13. The data collecting device 12 can collect the accelerator signals as the occupant data.

The brake pedal 34 generates brake signals based on the amount of braking by the driver's operation and outputs the signals to the automatic control device 11 and the data collecting device 12 via the in-vehicle network 13. The data collecting device 12 can collect the brake signals as the occupant data.

The UI 7 is an exemplary notification unit. The UI 7 is controlled by the automatic control device 11 and the data collecting device 12 to notify the driver of information regarding the vehicle 10. The UI 7 has a display device 7a such as a liquid crystal display or a touch panel for displaying information. The UI 7 may also have an acoustic output device (not shown) to notify the driver of information. The UI 7 also has a touch panel or operating button, for example, as an input device for inputting operation information from the driver to the vehicle 10. The UI 7 transmits the input data to the automatic control device 11 and the data collecting device 12 etc. via the in-vehicle network 13.

The automatic control device 11 controls the operation of the vehicle 10. The automatic control device 11 detects objects around the vehicle 10 and their types (e.g., a vehicle) based on the detection result of a front camera 2a, etc. The automatic control device 11 may detect objects and their types around the vehicle 10 using, for example, a machine-learned identifier. The automatic control device 11 controls the operation of the vehicle 10 based on the detection result of the objects around the vehicle 10 and the detection result of the vehicle sensor 6.

Further, the automatic control device 11 detects information such as the position of the sign around the vehicle 10, the size of the sign, and the telephone number represented on the sign based on the detection result of the front camera 2a, etc. The automatic control device 11 may detect environmental information such as the position of sign around the vehicle 10, the size of the sign, and the telephone number represented on the sign using, for example, a machine-learned identifier.

The automatic control device 11 outputs the environmental information including objects around the vehicle 10 and their types to the data collecting device 12, etc. via the in-vehicle network 13. The data collecting device 12 can collect the environmental information as the environmental data.

The automatic control device 11 detects the driver's line of sight direction and the opening degree of the mouth (hereinafter, also referred to as an opening degree) based on the monitoring image, and determines whether or not the driver is looking aside based on the detected line of sight direction and whether or not the driver is yawning based on the opening degree. Then, the automatic control device 11 monitors the state of the driver by detecting the frequency of the driver's looking aside and the frequency of the driver's yawning. The automatic control device 11 also outputs the frequency of driver's looking aside and the frequency of driver's yawning to the data collecting device 12 via the in-vehicle network 13.

The automatic control device 11 has an automatic operation mode for driving the vehicle 10 in the automatic operation, and a manual operation mode for controlling the operation of the vehicle 10 based on the operation of the driver. In the automatic operation mode, the automatic control device 11 mainly drives the vehicle 10. In the automatic driving mode, the automatic control device 11 generates automatic control signals for controlling the operation of the vehicle 10, such as steering, driving, and braking, based on the current position of the vehicle 10, map information, and detection results of sensors (not shown) such as the front camera 2a mounted on the vehicle 10, and outputs the automatic control signals to an actuator for driving the steering wheel, a driving device, or a brake via the in-vehicle network 13.

Further, in the manual operation mode, the automatic control device 11 controls the operation of the vehicle 10 such as steering, driving, and braking, etc. based on the operation of the driver. In the manual operation mode, the driver mainly drives the vehicle 10. In the manual operation mode, the automatic control device 11 generates manual control signals for controlling the operation of the vehicle 10 such as steering, driving, braking, etc. based on the operation of the steering wheel 32, the accelerator pedal 33 and the brake pedal 34 by the driver, and outputs the manual control signals to the actuator for driving the steering wheel, the drive device, or the brake via the in-vehicle network 13. The data collecting device 12 can collect the manual control signals in the manual operation mode and the automatic control signals in the automatic operation mode, as the occupant data.

The data collecting device 12 carries out collecting processing, generating processing, masking processing, and controlling processing. For this purpose, the data collecting device 12 has a communication interface (I/F) 21, a memory 22, and a processor 23. The communication interface 21, the memory 22, and the processor 23 are connected via signal wires 24. The communication interface 21 has interface circuitry for connecting the data collecting device 12 to the in-vehicle network 13.

The memory 22 has a volatile semiconductor memory and a non-volatile semiconductor memory, for example. The memory 22 may further has other storage devices, such as a hard disk drive. The memory 33 stores an application computer program and various data to be used for information processing carried out by the processor 23. The memory 22 also stores the vehicle data.

The vehicle data includes the occupant data, driving data, and environmental data, etc., depending on the collecting information. Information of the attribute to be protected in the vehicle data is provided to the outside after the masking processing has been carried out.

All or some of the functions of the data collecting device 12 are functional modules carried out by a computer program operating on the processor 23, for example. The processor 23 has a collecting unit 231, a generating unit 232, a masking processing unit 233, and a control unit 234. The generating unit 232 is an example of a first generating unit and a second generating unit. Alternatively, the functional module of the processor 23 may be a specialized computing circuit in the processor 23. The processor 23 has one or more CPUs (Central Processing Units) and their peripheral circuits. The processor 23 may also have other computing circuits such as a logical operation unit, numerical calculation unit or graphics processing unit. The data collecting device 12 is, for example, an Electronic Control Unit (ECU).

When it has been determined that the vehicle 10 is located in an area where the vehicle information is to be collected based on the positioning information, the collecting unit 231 starts collecting the vehicle information. The collecting unit 231 collects the vehicle information including the occupant data, the driving data, and the environmental data based on the collecting information, and stores them in the memory 22.

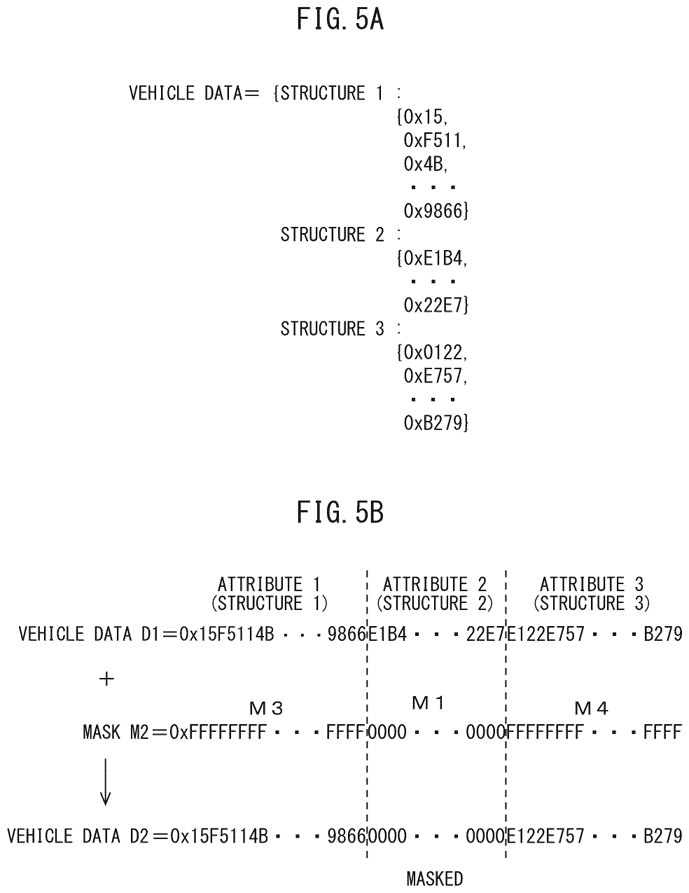

FIG. 5A is a diagram illustrating an example of the vehicle information. In the vehicle information, for example, each of a plurality of non-image information with different attributes is disposed as a structure. The vehicle data has a structure 1 having an attribute 1 representing the driving data, a structure 2 having an attribute 2 representing the occupant data, and a structure 3 having an attribute 3 representing the environmental data. In each structure, the data is represented in hexadecimal. 0x is a prefix that indicates hexadecimal. For example, if the vehicle information has 200 8-byte variables, the size of the vehicle data would be 1600 bytes (8 bytes×200). The details of the operation of the data collecting device 12 will be described later.

In the example shown in FIG. 3, although the collecting unit 231, the generating unit 232, the masking processing unit 233, and the control unit 234 are arranged in one device, the generating unit 232, the masking processing unit 233 and the control unit 234 may be arranged in a separate device from the collecting unit 231.

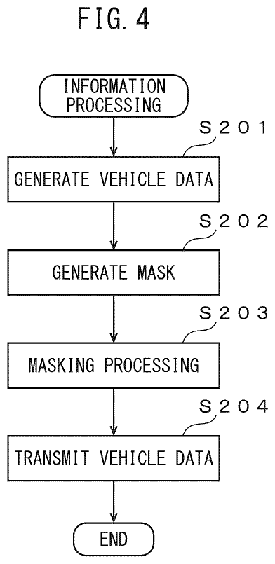

FIG. 4 is an example of an operation flowchart of the information processing of the data collecting device 12. Hereinafter, information processing of the data collecting device 12 will now be described with reference to FIG. 4. The data collecting device 12 carries out the information processing shown in FIG. 4 at an information processing time having a predetermined period.

First, the generating unit 232 generates the vehicle data based on the vehicle information (step S201). The generating unit 232 generates serial data in which each of a plurality of non-image information with different attributes is disposed at a predetermined position, as the vehicle data based on the vehicle information.

In the example shown in FIG. 5B, the structures 1 to 3 in the vehicle data D1 are arranged in order. In each of structures 1 to 3, 8 bytes of data are arranged sequentially. In the example shown in FIG. 5B, the vehicle data D1 is shown in hexadecimal, but in practice the vehicle data D1 is represented by a plurality of bit 0 and bit 1.

Next, the generating unit 232 generates a mask M1 having the serial data of the same length as the information of the attribute 2 to be protected with respect to the information of the attribute 2 (structure 2) to be protected in the vehicle data D1 (step S202). The mask M1 may be serial data having the same length as the data of the structure 2 representing the occupant data.

In the example shown in FIG. 5B, the generating unit 232 generates a mask M2 having serial data of the same length as the vehicle data D1. In the mask M2, the mask M1 is disposed at a position corresponding to a position where the information with the attribute 2 to be protected is disposed in the vehicle data D1. In the mask M2, the bits other than the portion where the mask M1 is disposed are 1. In the example shown in FIG. 5B, the 8-byte bits are represented by a hexadecimal FF. In embodiments, the mask M1 is zero-bit for all. In the mask M1, bit 0 and bit 1 may be randomly arranged.

In the mask M2, the mask M3 with all 1 bits, the mask M1 with all zero bits, and the mask M4 with all 1 bits are disposed in this order. The mask M3 has serial data of the same length as the information of attribute 1 (structure 1) not to be protected in the vehicle data D1, and the mask M4 has serial data of the same length as the information of attribute 3 (structure 3) not to be protected in the vehicle data D1.

Next, the masking processing unit 233 carries out the masking processing on the vehicle data D1 using the mask M2 (step S203). The masking processing is an example of the concealing processing. The data collecting device 12 carries out the masking processing so that information is concealed with respect to the information of the attribute to be protected and information is not changed with respect to information of an attribute not to be protected by using the mask M2. The mask M2 is exemplary protection serial data. Specifically, the masking processing is carried out so that the start bit and the end bit of the mask M1 correspond to the start bit and the end bit of the information of the attribute 2 to be protected. Specifically, the masking processing unit 233 carries out an AND operation between the vehicle data D1 and the mask M2 to obtain the vehicle data D2.

As a result of the AND operation, information of the attribute 2 to be protected becomes all zero bits in the vehicle data D2. This makes it impossible to decode any information with the attribute 2 in the vehicle data D1. In embodiments, from the viewpoint of protecting information, the masking processing uses an irreversible mask.

Also, in the vehicle data D2, the information of the attribute 1 not to be protected and the attribute 3 not to be protected does not change from the vehicle data D1 by the AND operation. The masking processing protects only the information of the attribute 2 in the vehicle data D2. The masking processing may be carried out using a logical operation other than the AND operation.

In the above-described masking processing, the processing amount required for the masking processing can be greatly reduced, since the information with the attribute 2 can be protected with a single random access operation and an AND operation with respect to the vehicle data D1 stored in the memory 22.

For example, in the vehicle information shown in FIG. 5A, it is required for random 200 times accesses for 200 variables stored in the memory 22 when the information of the attribute 2 is protected at the variable level. Therefore, the data collecting device 12 of the present embodiment can greatly reduce the processing amount in the masking processing.

Next, the control unit 234 transmits the vehicle data D2 to the server 30 using the communication device 3 (step S204), and the series of the processing steps is complete.

In the description described above, the subject matter of protection was the occupant data represented by the attribute 2. The subject matter of protection may be changed due to changes in laws and regulations. For example, when the driving data is protected, a mask M3 having serial data of the same length as the attribute 1 may be used with respect to the information of the attribute 1 to be protected in the vehicle data D1. In this case, a mask in which all bits are zero may be used as the mask M3.

Similarly, if the environmental data is protected, a mask M4 having serial data of the same length as the attribute 3 may be used with respect to the information of the attribute 3 to be protected in the vehicle data D1. In this case, a mask in which all bits are zero may be used as the mask M4.

As described in detail above, the data collecting device of the present embodiment can can easily protect a portion of information collected from the vehicle that is to be protected, in response to changes in the subject of protection.

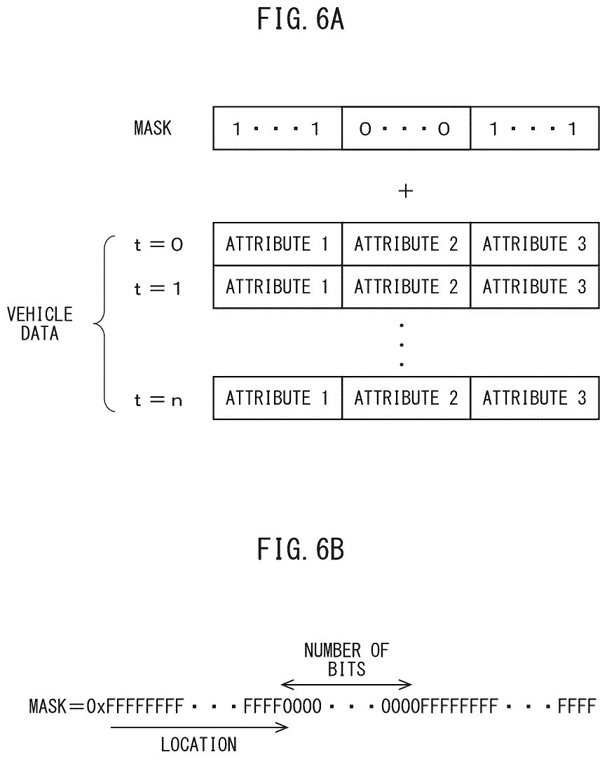

Next, a modification example of the data-collection device of the present embodiment described above will be explained below with reference to FIG. 6A. FIG. 6A is a diagram for illustrating a modified example of the data collecting device 12.

The data collecting device 12 may transmit a plurality of collected vehicle data together to the server 30. For example, the data collecting device 12 transmits n vehicle data from time t=0 to time t=n in order. The data collecting device 12 sequentially transmits n vehicle data after the masking processing for each of the n vehicle data using the protection mask.

The information processing device according to the above-described embodiment of the present disclosure may incorporate appropriate modifications that are still within the gist of the present disclosure. Moreover, the technical scope of the present disclosure is not limited to the embodiments described herein and includes the present disclosure and its equivalents as laid out in the claims.

For example, in the above-described embodiment, the protection mask used for the masking processing has been generated by the data collecting device, but the protection mask may be received from the server. If the type of personal information to be protected by laws and regulations is determined, a protection mask may be delivered from the server to the data collecting device. In this case, the structure of serial data in which each of a plurality of non-image information with different attributes is disposed at a predetermined position in the vehicle information is shared in the server and the data collecting device.

As shown in FIG. 6B, the information transmitted from the server to the data collecting device may be information representing the location in the vehicle data where the information of the attribute to be protected is disposed and the length of the information of the attribute to be protected. The generating unit of the data collecting device may generate a mask M1 and a mask M2 based on the information. Thus, the amount of information transmitted from the server to the data collecting device can be reduced.

The server may also transmit a protection mask to the data collecting device in response to the driver using a terminal to send a request to the server to transmit the protection mask to the data collecting device.

The data collecting device may also generate a protection mask in response to being notified of a request to generate a protection mask using the UI by the driver.

Further, AND operations of the two or more masks generated as described above may be carried out to execute the masking processing of the vehicle data.

Also, in the embodiments described above, the vehicle data has serial data in which each of a plurality of non-image information with different attributes is disposed at a predetermined position, whereas the vehicle data may have serial data in which the information of one or more images with different attributes is disposed at predetermined positions.

Further, the attributes of the vehicle data in the above-described embodiment is an example, the attributes of the vehicle data is not limited thereto. For example, in the above-described embodiment, the environmental data includes sign information such as the position of the sign around the vehicle, the size of the sign, and the telephone number represented on the sign, and other vehicle information such as the position of other vehicles around the vehicle, the vehicle identification mark, size, and color, but the sign information may be different attribute from other vehicle information.

In the above-described embodiment, the masking processing has been carried out using the protection serial data in which the protection mask is disposed at the position corresponding to the information of the attribute to be protected and has the same length as the vehicle data. However, if the masking processing is carried out using the protection mask with respect to the information of the attribute to be protected in the vehicle data, the masking processing may be carried out without using the protection serial data.

Further, in the embodiments described above, the information to be protected has been associated with the personal information, but the information to be protected may not be associated with the personal information.

1. An information processing device comprising:
a processor configured to
generate vehicle data having serial data in which a plurality of non-image information with different attributes is disposed in predetermined positions,
carry out concealment processing with respect to information of the attribute to be protected in the vehicle data using a protection mask having serial data of the same length as information of an attribute to be protected, and;
an output device for outputting the vehicle data subjected to the concealment processing.

2. The information processing device according to claim 1, wherein the processor is further configured to carry out the concealing processing so that information is concealed with respect to the information of the attribute to be protected and information is not changed with respect to information of an attribute not to be protected by using protection serial data including the same length as the vehicle data in which the protection mask is disposed at a position corresponding to the information of the attribute to be protected.

3. The information processing device according to claim 2, wherein all bits of the protection mask are zero.

4. The information processing device according to claim 2, wherein the processor is further configured to generate the protection mask and the protection serial data based on a position of the information of the attribute to be protected in the vehicle data and a length of the information of the attribute to be protected.

5. The information processing device according to claim 1, wherein the information of the attribute to be protected is associated with personal information.
